(19) United States
(12) Patent Application Publication
(10) Pub. No.: US 2012/0041675 A1
(43) Pub. Date: Feb. 16, 2012

(54) Method and System for Coordinating Transportation Service

(76) Inventors: Steven Juliver, Tucson, AZ (US); Earl Epstein, Toronto (CA); Michael Carlos Geraldes, Toronto (CA)

(21) Appl. No.: 13/207,288

(22) Filed: Aug. 10, 2011

Related U.S. Application Data
(60) Provisional application No. 61/372,244, filed on Aug. 10, 2010.

(51) Int. Cl. G06Q 50/30; G06Q 50/32; G06Q 10/08

(52) U.S. Cl. 701/465; 705/1.1; 701/533; 701/522; 705/400

(57) ABSTRACT

A method and system for coordinating transportation service is provided. A request is received for a trip generated by a client application executing on a mobile device. Which one of a set of transportation vehicles is best suited to provide the trip is determined. The one transportation vehicle to provide the trip is automatically dispatched.

This application claims priority from U.S. Provisional Patent Application No. 61/372,244 filed on Aug. 10, 2010, the entire contents of which are incorporated herein by reference.

### FIELD OF THE INVENTION

The present invention relates generally to the transportation industry. In particular, the invention relates to a method and system for coordinating transportation service.

### BACKGROUND OF THE INVENTION

The majority of ground transportation service providers, from taxi to limousine to tow truck companies, operate using the same dispatching methodology and technology they have used for decades. It is error prone, inefficient, inconvenient, and potentially dishonest. Using such traditional systems, scheduling a trip can be time-consuming and frustrating for people. Unexpected delays encountered by transportation service providers in getting to passengers can lead to unhappiness and lost customers.

It is therefore an object of the invention to provide a novel method and system for coordinating transportation service.

### SUMMARY OF THE INVENTION

According to an aspect of the invention, there is provided a method for coordinating transportation service, comprising:

receiving a request for a trip generated by a client application executing on a mobile device;

determining which one of a set of transportation vehicles is best suited to provide said trip; and

automatically dispatching said one transportation vehicle to provide said trip.

The automatically dispatching can be delayed if the request for the trip specifies a delayed pick-up.

The receiving can include receiving a preference for a route for the trip with the request. The preference can correspond to a characteristic of the trip. The characteristic can include at least one of: duration, smoothness, scenery, and directness. The preference can correspond to at least one location along the route.

The method can further include:

determining a best route for said trip; and

transmitting said best route to said mobile device.

The method can further include presenting the location of the mobile device relative to the best route on the mobile device.

The receiving can include receiving a pick-up location, a drop-off location and a desired pick-up time.

The method can further include:

receiving the geolocation of said mobile device, and

estimating if said mobile device is expected to be at said pick-up location at said desired pick-up time.

The method can further include:

receiving the geolocation of said mobile device; and

transmitting a prompt to said mobile device if said mobile device is a threshold distance from said pick-up location, said prompt enabling a client operating said mobile device to specify a revised pick-up location.

The method can further include:

iteratively receiving the geolocation of said mobile device, and

determining if said mobile device appears to be in a vehicle traveling to said drop-off location.

The method can further include:

reiteratively receiving geolocation information for an other of said transportation vehicles; and

determining if said mobile device is in said other transportation vehicle by tracking colocation of said mobile device and said other transportation vehicle.

The method can further include:

providing said trip;

receiving a recall request for said one transportation vehicle; and automatically dispatching said one transportation vehicle to a drop-off location.

The method can further include reiteratively transmitting the geolocation of the one transportation vehicle to the mobile device.

The method can further include automatically transmitting an estimated arrival time at a pick-up location to the mobile device.

The method can further include:

receiving a subsequent request for a separate trip generated by said client application executing on a second mobile device; and

considering said one transportation vehicle dispatched to provide said trip when determining which of said set of transportation vehicles is best suited to provide said separate trip.

According to another aspect of the invention, there is provided a system for coordinating transportation services, comprising:

a transportation service provider system having a network interface receiving a request for a trip generated by a mobile device and receiving geolocation information from a set of transportation vehicles, said transportation service provider system executing an application determining which one of said transportation vehicles is best suited to provide said trip and automatically transmitting dispatch instructions to said one transportation vehicle.

According to a further aspect of the invention, there is provided a method for coordinating transportation service, comprising:

reiteratively receiving geolocation information from a first mobile device of a first client and a second mobile device of a second client;

providing a first trip to said first client with a transportation vehicle;

providing a second trip to said second client with said transportation vehicle, at least a portion of said second trip being provided simultaneously with said first trip; and

determining a pro-rata portion of transportation service charges incurred during occupancy of said transportation vehicle by each of said first and second clients.

### BRIEF DESCRIPTION OF THE DRAWINGS

Embodiments will now be described, by way of example only, with reference to the attached Figures, wherein:

FIG. 1 shows a high-level architecture of a system for coordinating taxi service in accordance with an embodiment of the invention and its operating environment;

FIG. 2 shows a schematic diagram of a transportation service provider system of FIG. 1;

FIG. 3 is a flow chart of the general method of coordinating transportation service using the system of FIG. 1; and

FIG. 4 is a flow chart of the process of requesting a trip in the method of FIG. 3.

### DETAILED DESCRIPTION OF THE EMBODIMENTS

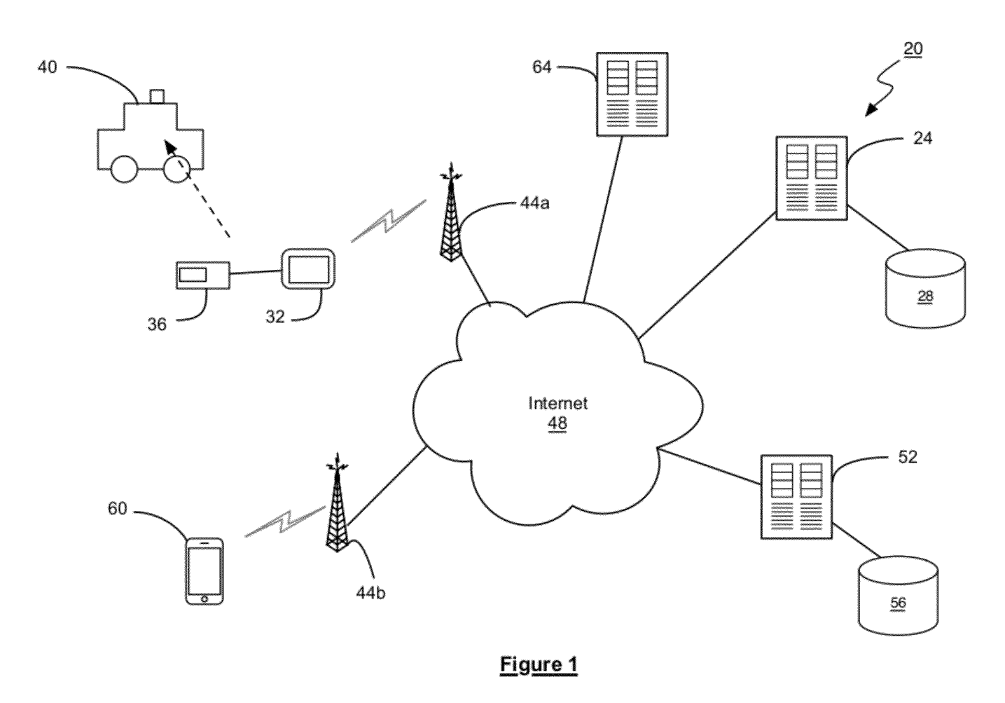

FIG. 1 shows a system for coordinating taxi service in accordance with an embodiment of the invention generally at 20. The system enables a person (hereafter referred to as a “client”) needing access to, for example, taxi, livery, limousine, shuttle or towing services, or any other form of public or private on-demand transportation (hereinafter referred to as “transportation services”) that allows access to automated or semi-automated end-to-end vehicle dispatching, tracking, payment and/or other services.

The system 20 includes a transportation service provider system 24.

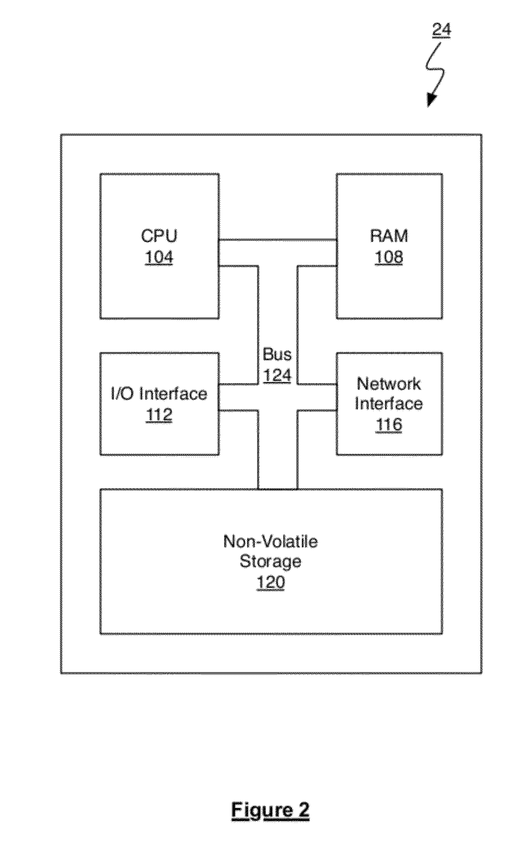

FIG. 2 shows various physical elements of the transportation service provider system 24. As shown, the transportation service provider system 24 is a computer system that has a number of physical and logical components, including a central processing unit (“CPU”) 104, random access memory (“RAM”) 108, an input/output (“I/O”) interface 112, a network interface 116, non-volatile storage 120, and a local bus 124 enabling the CPU 104 to communicate with the other components. The CPU 104 executes an operating system and a transportation service management and dispatching application. RAM 108 provides relatively-responsive volatile storage to the CPU 104. The I/O interface 112 allows for input to be received from one or more devices, such as a keyboard, a mouse, etc., and outputs information to output devices, such as a display and/or speakers. The network interface 116 permits communication with other systems. Non-volatile storage 120 stores the operating system and programs, including computer-executable instructions for implementing the transportation service management and dispatching application, and data used by the application. During operation of the transportation service provider system 24, the operating system, the programs and the data may be retrieved from the non-volatile storage 120 and placed in RAM 108 to facilitate execution.

Returning again to FIG. 1, the transportation service provider system 24 may be a single physical computer or may be two or more computers cooperating to provide the functionality described herein. Further, where the transportation service provider system 24 includes two or more physical computer systems, it may be physically located at one facility or may be distributed including geographically. Typically, the transportation service provider system 24 resides in the premises of a transportation service provider. As will be understood, the system 20 can include more than one the transportation service provider system 24 corresponding to more than one transportation service provider. The transportation service management and dispatching application executed by the transportation service provider system 24 may be offered as a Software as a Service (“SaaS”) application that may be accessible through either a Web interface or a proprietary application over various types of wired or wireless networks or though the Internet 48.

The transportation service provider system 24 manages a provider database 28. The provider database 28 stores cab data, driver data, automatic vehicle location (“AVL”) data, user data, street network data, cab status data, trip request data, financial data, etc. The cab data includes various information about each cab that is available to the taxi service provider. This information can include, for example, the type of car that the cab is, a unique cab ID, its licensing credentials the condition of the car (such as when it is due for maintenance), whether the car is equipped with air conditioning, the maximum number of passenger seats, if it is equipped with child seats and/or child seat anchors, whether the vehicle is “wheel chair accessible”, whether smoking is permitted, whether the vehicle is equipped with snow tires, etc. The driver data includes the name and sex of the driver, a unique driver ID, their license information and status, their driving record, the languages spoken by the driver, areas the driver has knowledge of, etc. The user data includes the name, age and sex of the user, a unique user ID, the residential address, their preferred or home default city, a dynamic list of frequently visited locations, route type and other preferences, billing and payment information such as account terms, credit card information, the mobile telephone number, email address and other contact information, vehicle, driver, and route attribute preferences, typical number of accompanying passengers, willingness to share rides with other passengers and any associated preferences or rules, negative comments contributed by drivers, etc. The trip request data includes the name and telephone number of the requesting party, the unique user ID if available, the pick-up location, the drop-off location, the desired pick-up time, the urgency of the trip and any requirements for the trip, such as the number of passengers, luggage and other capacities, etc. The live vehicle data includes an identification of how many passengers each cab has, which cabs are en route to pick up a client, which cabs are available for new trip requests, the pick-up and drop-off locations of clients the cabs are scheduled to provide rides for or of clients the cabs are transporting, the planned or recommended route, on or off duty status, vehicle operating telemetry provided by OBD and other sensors, microphones and cameras. The AVL data includes a cab ID and a geolocation for each cab that is transmitting its geolocation, its speed and direction, road and traffic conditions near the cab and/or along its route, which zone it is in (if it's service area has been divided into polygonal zones) and any sudden changes that may indicate the occurrence of a collision or similar accident. The financial data tracks the fares generated by each cab and by each driver, the method of payment and payment details such as approval code, location, and time of transaction, the status of the client's account if one exists, any accrued loyalty points, rebates, bonuses and/or the client's status level (e.g., “gold frequent rider”).

The street network data includes information about the local and surrounding geographical areas. This data includes information for each street network segment. Street network segments are stretches of road that span between two intersections. An intersection is a location at which more than one road may be selected. Street network segments are directional; thus, for streets with bidirectional traffic, two street network segments represent a stretch of road between intersections. Travel time for different times of the day can be stored for each street network segment. Further, special rules for transferring from one street network segment to another can be stored. For example, turns from one street network segment to another (e.g., a left turn) may be prohibited at certain times of the day. Points of interest such as hospitals, hotels, gas stations, museums can be stored along with detailed information regarding each, This information may be stored as text, voice, video or any combination of these or other types of media. Points of interest may include commercial outlets like malls, cinemas, retail stores and places to acquire service or entertainment such as theater or musical performance venues or bars, for which a fee has been paid to acquire their placement in the database. The data may include details regarding location-based coupons, special offers and other incentives.

A tablet computer 32 is shown being coupled to a taxi meter via an RS-232 (serial) interface. The tablet computer 32 and the taxi meter are installed in a taxi 40. The tablet computer 32 receives meter data from the taxi meter 36, including the distance and time traveled, and the fare. In some other cases, however, taxi meter information can be determined by the tablet computer 32. The tablet computer 32 is in communication with a cellular communications tower 44a. The cellular communications tower 44a is coupled to the Internet 48 via a number of intermediate servers and gateways operated by a cellular communications provider (not shown).

The tablet computer 32 executes a taxi application for communicating with the transportation service provider system 24, and includes a touch screen enabling a driver to interact with the taxi application. The taxi application transmits and receives dispatch, navigation, tracking, payment and fleet management information associated with taxis and their drivers. The tablet computer 32 determines its location using a built-in Global Positioning System (“GPS”) radio and software.

A client management server 52 is in communication with the transportation service provider system 24 via the Internet 48. The client management server 52 manages the client data stored in a client database 56. The client management server 52 also communicates with other systems, such as:
payment processing services;
geopositioning, geolocation and GIS services;
advertising and/or marketing systems and services;
security services
client relationship management services; and
accounting and related services.

Clients interact with the system 20 primarily via a mobile device 60. The mobile device 60 is a computing device that is capable of cellular communications, such as a smartphone. Preferably, the mobile device 60 also has geolocation functionality to enable the mobile device 60 to determine its location geographically. For example, the mobile device 60 may include a GPS radio and software. The mobile device 60 is in communication with the client management server 52 via cellular communications tower 44b. Like cellular communications tower 44a, cellular communications tower 44b is coupled to the Internet 48 via a number of intermediate servers and gateways operated by a cellular communications provider (not shown).

The mobile device 60 executes a client application for communicating with the client management server 52.

The client application enables the client to perform a number of tasks, including:
schedule trips with the transportation service provider;
locate nearby vehicles and identify which are available;
specify particular vehicle or driver attributes for trips;
reserve a vehicle by pre-booking a dispatch;
receive confirmation that a dispatch request has been accepted;
identify and track a specific vehicle that has accepted a dispatch request;
send a specific request to a dispatched vehicle's driver;
delay a vehicle's arrival;
schedule an earlier time for a vehicle's arrival;
cancel a dispatch request;
pay for services rendered and related costs, including redeeming loyalty bonuses such as points and rewards; and
pre-pay for services to be rendered and for related costs.

One or more external news servers 64 are also coupled to the Internet 48. The transportation service provider system 24 is in communication with the external news servers 64 to obtain weather information, traffic information, etc.

### Setup

In order to use the mobile device 60 with the client management server 52, the client application may be installed on the mobile device 60. Upon installation of the client application, the client is prompted to either log in if he is an existing user of the system, or create an account. The client may decide not to create an account, however this may limit the functionality of the client application. To create an account, the client selects a login name and password, and a personal identification number (“PIN”). Further, the client can:
input persistent information that can be stored on the mobile device 60 or on the client management server 52, such as name, residential address, credit card and billing information, a photograph, the client's company, etc.;
configure their default vehicle preferences;
specify types of points-of-interest the user is interested in being alerted to (if any) along the route of their travel;
select normal or reduced data transfer volume (to reduce roaming charges); this may be accomplished, for example, by providing the client text-based route and location information rather than downloading and displaying map tiles, or by allowing the client to pre-cache certain information such as desired map tiles and/or lists of street names and points-of-interest prior to leaving their local data network's range; and
select and configure which widgets to display.

The user login credentials can be stored by the client application, which can require the client to input the PIN to have the client application send the client login credentials to the client management server 52 for authentication.

### Operation of the System

Once the client application is set up on the mobile device 60 and a client account is created for the client, the client can use the client application installed on the mobile device 60 to interact with the client management server 52 and the transportation service provider system 24. One of the fundamental functions that can be performed using the client application is the booking of a trip.

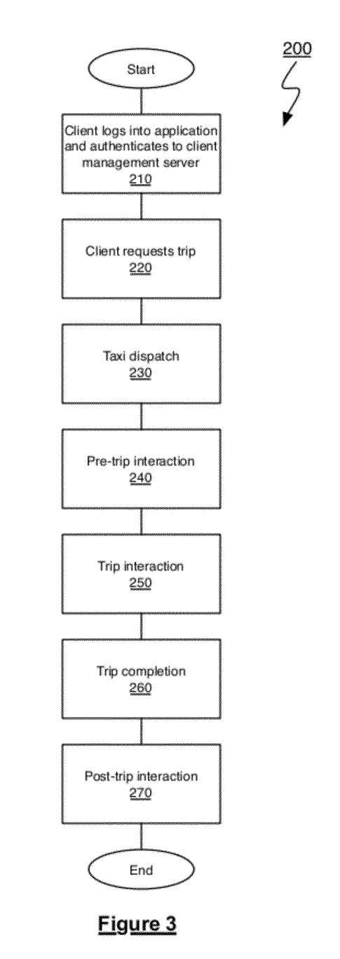

FIG. 3 is a flowchart of the general method 200 of booking a trip using the client application installed on the mobile device 60. The method 200 commences with the client logging into the client application and authenticating to the client management server (210). The client logs into the client application by entering his PIN. The client application then transmits the client's login credentials to the client management server 52 to authenticate the client.

Once the client has logged in, the client selects to request a new trip (220). A new trip may consist of the process of acquisition, retrieval and communication of several pieces of information intended to facilitate a client's request for fulfillment of specific trip requirements via the taxi company. These pieces of information may be stored or cached when first acquired, and re-accessed subsequently, to facilitate the functions described herein. Such information may also be input by the client at the time of the dispatch request. In order to request a new trip, the client enters in specifics for the trip, including, but not limited to, entering in the pick-up location and the drop-off location (i.e., the destination), the desired time for the pick-up, and any specific requirements.

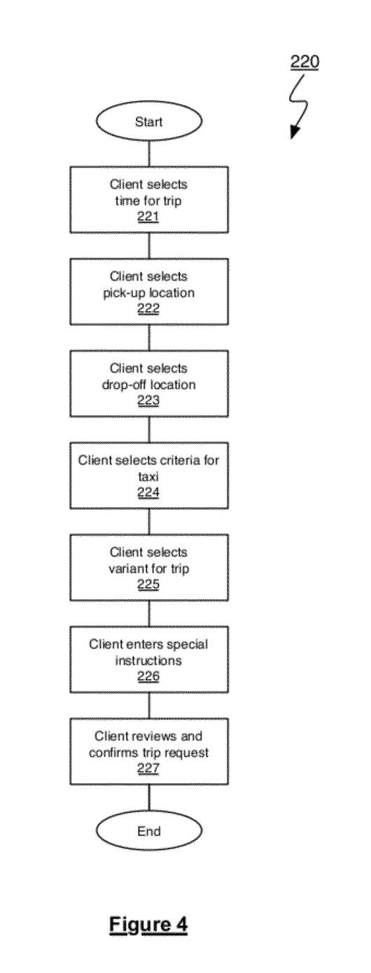

FIG. 4 shows the requesting of a trip by the client in greater detail. First, the client enters the pick-up and drop-off locations (221, 222). The client can enter the pick-up and destination addresses in a variety of ways, including:
typing or speaking the address;
typing or speaking a “nickname” (e.g., “Home”) for an address;
typing or speaking a landmark or point-of-interest name;
recalling the address from a pre-defined list of “favorite” addresses or locations;
recalling the address from a stored list of “recent” trips;
acquiring the address from the mobile device's address book;
acquiring the address from a server on the Internet 48, based on user-identified landmark or point-of-interest (e.g., “Carnegie Hall” or “hospital”);
entering a partial address or point-of-interest, and selecting from a list of possible matches on the mobile device 60. In the last scenario, if the client begins to type “main st.” their mobile device 60 may display all streets beginning with the initial letters typed. The mobile device 60 may also require the user to type a minimum number of letters, for example to limit the list of possible matches, before displaying the list of possible matches, such that a list may not be displayed until the user types more than one letter, for example, when they type the second letter “A” the system may display all streets beginning with the letters “Ma.” In this way, the client may be able to choose an address or point-of-interest without having to have entered the entire address or description for that address or point-of-interest. Further, the data for the list of possible matches may be stored locally, remotely, or a combination of both.

Any of these addresses, point-of-interest, or pre-defined locations, for any module described herein, may be assigned a designator such as a “nickname.” Such designators or nicknames may be defined by the client, and may be stored locally on the mobile device 60 or elsewhere.

Alternatively, the client can define and select from a list of “favorite” trips. Here, the client can save a defined trip or location to the list of “favorites”. The list can be stored on the mobile device 60 or on the client management server 52. The client may be able to assign a nickname to each “favorite” to aid in recognition—e.g., “Home to Work” or in the case of a favorite, just “Gym.” “Favorites” may be stored with user-defined additional specifications—i.e., a “favorite” that might be called “DayCare” may have the specification attached to it to automatically request dispatch of a minivan along with the recall of pick-up and destination address or coordinates. If a destination or route has been entered more than once, the mobile device 60 may offer the client an option to add the destination or route to their “favorites”.

The client application also enables the client to select a trip or location that was recently entered. This enables the client to review or recall the details of a recent trip from any of a number of automatically stored and updated recently-traveled trips which may be shown by name, address, or both—e.g., “Hotel to Microsoft Offices” or “10 Downing St., London to 221b Baker St., London”. Alternately, the number of stored trips may be limited only by mobile device features, such as amount of non-volatile storage, or the stored trip information may be stored elsewhere such as at the client management server 52 or the transportation service provider system 24. This may recall all details of that trip including pick-up and/or drop-off addresses, vehicle and driver information, payment and/or route and/or time and/or vehicle requirement and/or special instruction details. The client may also save a recent trip to “favorites”.

The client can request the pick-up as soon as possible or can select a delayed/scheduled pick-up (i.e., a “pre-book”) (223). The client may be able to confirm, cancel, modify, or delay the pre-booked trip from their mobile device 60. Details of pre-booked trips may be stored on the transportation service provider system 24 or the client management server 52. Scheduled pick-up time may be accelerated or delayed by the client, simply by their selection of pre-set delay time intervals; for example, 15 minutes, or may be able to enter a specific number of minutes by which they wish pick-up accelerated or delayed. Scheduled pick-up dates may be changed in a similar manner. This information may be handled by client management server 52 and/or the transportation service provider system 24 to dispatch the vehicle to the appropriate location at the appropriate time, and may use the algorithms referred to earlier. The client may be able to schedule a notification alarm at a specified amount of time before the pre-booked vehicle is due to arrive, to ensure that they still want to acquire that vehicle.

Once the pick-up time has been entered, the client selects criteria for the taxi and driver (224). The client can select from one or many options, or chose no options, to insure that a vehicle conforms to the extent possible to the client's specific requirements—e.g., obtaining a vehicle that is air-conditioned, handicap-accessible, of a certain size, or that meets certain minimum requirements or sets of requirements.

The client can also select from one or many options, or chose no options, to insure that a vehicle driver conforms to the extent possible to one or more characteristics, such as language fluency, particular provider, gender, etc.

The client can request a “variant” of a route from a pick-up location to a destination location (225). For example, variant options may include the “most direct route”, “fastest likely route” (which may incur extra cost because it may not be shortest), “scenic route” (which may avoid highways etc.), or “smoothest route” (for example, in the case of a rider in pain). These route types may be predetermined and may be stored on the transportation service provider system 24 or the client management server 52, and delivered to the driver along with the dispatch request and other information. These route types may be established using an algorithm which may be part of the transportation service provider system 24 or the client management server 52 and that can but is not required to assess both constant (such as distance) and variable (such as speed of traffic, road work, etc.) factors and that may make route recommendations to the driver based on, for example, just-in-time prediction of the route that best addresses the client's route request. If no variant is specified by the client, the transportation service provider system 24 will default to selecting and transmitting to the driver an optimal route based on variables that can be specified by the transportation service provider.

The client may enter special instructions for the driver (226). This may be selectable from a list of instructions (including pre-defined instructions) such as “please do not ring doorbell,” “I would like assistance with my luggage,” “I will be at the side entrance,” or may be entered as a custom message by the client such as “There are several people where I am waiting. I am wearing a red coat”. Custom messages may also be used, and may be added to or removed from the preset messages list by the client or at the software modules described above.

Once the client has entered the trip information, the client confirms it (227). The mobile device 60 presents a summary of the trip information to the client for confirmation. The client can correct inaccuracies in the trip information by selecting to be brought back to the trip entry screen. In addition, the mobile device 60 can receive and present the dispatch request and/or any selected or entered details of the new trip, and receive additional information which may include notice of unavailability or change in arrival time such as amount of expected delay in receiving service that conforms to some or all of the requirements specified in the trip details. This includes the estimated wait time until the dispatched vehicle arrives, based on calculations, which may include averaging the drive times for a set number of the closest available vehicles conforming to the client's specifications. Further, the mobile device 60 presents the approximate cost for the trip (or exact cost when applicable).

If the client is satisfied with the trip information, the client confirms the trip to schedule it.

The transportation service provider system 24 and/or the client management server 52 may confirm, and may simultaneously store trip details to a “favorites” file.

Returning again to FIG. 3, a taxi is then dispatched (230). If the trip request is for an immediate pick-up, or if the trip request is pre-booked and the desired pick-up time is approaching, a taxi is dispatched to provide the trip. The transportation service provider system 24 selects an available taxi closest to the pick-up location that meets the criteria specified by the client. Alternatively, the transportation service provider system 24 may select that taxi which would likely arrive soonest and that meets the criteria specified by the client.

When the taxi is dispatched, the client can be notified on their mobile device 60. The client may also receive information along with the acceptance confirmation, such as:
the vehicle's type;
estimated time of arrival;
transportation service provider—e.g., “Yellow Cab”;
vehicle number;
make, model and color of vehicle;
driver's name; and
photo.

Once the taxi is dispatched, the client can view the location and approach of the dispatched vehicle on the mobile device 60 (240). The client can view the location and approach of the dispatched vehicle on their mobile device 60. The client can request a delay or other change in time of pick-up via their mobile device 60, and can send a message to the driver prior to arrival at pick-up location (e.g., “I have moved, and I am now at the side door”). The driver can send message to the client; e.g., “I am delayed due to heavy traffic” or “I will be at your location in approximately 2 minutes”. Driver messages may be sent to the client's mobile device 60 using “push” or “pull” technology so as to be displayed regardless of what the mobile device 60 is being used for at the time the message is received.

Once dispatched, the mobile device 60 and the tablet computer 32 transmit their geolocation to the client management server 52 and the transportation service provider system 24 respectively. The client application and/or the client management server 52 can scan the client's list of favorite, or past pick up locations, and/or the user's mobile device's contacts directory or address book, in order to find addresses close to the pick-up location. In the event a match or near match is found, the client application may identify this/these to the client as possible intended pick up locations, from which the client may select one if it is a preferable or more accurate pick-up location. One benefit of this feature may be where the client's mobile device 60 does not identify the client's location with high accuracy, or high confidence. For example, if the client application, when trying to identify the client's location, determined the client's location to be at 100 Main St., and the client's office or home was at 130 Main St. and was listed in the client's favorite pick-up locations list, or had been used as a pick-up location previously, or was stored in their mobile device's address book, the client application and/or the client management server 52 may identify the 100 Main St. location as well as the possible intended pick-up location(s). In these cases, the client application may indicate the multiple possible intended pick-up location(s) from which the client may select. In addition, the client application may present the client with a request for confirmation of the pick-up location, for example by sending a message such as “are you at the office”, or “are you at 130 Main St.?” The client may then reply to convey the appropriate response.

The client application monitors or occasionally polls the client's speed and location after a dispatch has been requested. If the client's mobile device 60 registers a pre-determined speed or distance from the location from which a request for dispatch was made, an assumption may be made by the client application or the client management server 52 that the client is already in another vehicle. This assumption may initiate a communication to the client to confirm if they still require a vehicle such as via a push message. The client may be able to cancel the original request or in the event that they are moving in a system-integrated or other appropriately equipped vehicle, confirm that another vehicle has picked them up, and identify that vehicle to enable other features of the system.

The transportation service provider systems can compare the client's location updates with the locations of any system-integrated or other appropriately equipped vehicles close to the client. If the transportation service provider system 24 determines that a client and a system-integrated vehicle are traveling on the same route at the same speed, it may conclude that the client is likely in that vehicle. The client application can prompt the client to confirm that they are in a specified system-integrated vehicle by entering some form of vehicle ID. This process can eliminate the need for clients to manually identify when they are in a system-integrated vehicle, and the need to input system-integrated vehicle ID to activate client application features.

The system 20 may improve GPS accuracy and/or confidence by comparing GPS coordinates with a series of other accuracy checks. For example, a client takes a picture of a building or storefront where they are located using the camera in their mobile device 60. The image can be either uploaded to the client management server 52 for analysis or analyzed locally. The analysis procedure compares the newly-photographed image(s) to images within a pre-defined radius of the location at which the client's mobile device 60 has determined them to be. These reference images may be hosted or obtained via accessing 3^{rd} party service like “Google Street View”. In comparing the photograph taken by the end user to available images within a reasonable range, the client management server 52 and/or the client application may attempt to identify key elements shared by the client's photographed image(s) that aid in confirming the client's location.

In another example, the client management server 52 may use Wi-Fi SSIDs (i.e., identifiers of wireless networks) by building and maintaining a its own database that may join SSID information with the known location of the Wi-Fi signal, or the GPS coordinates identified when the signal is strongest, and/or using and contributing to 3^{rd} party service such as Navizon. The client application and/or the client management server 52 may record transmitted SSIDs by strength and store them along with GPS coordinates. Data is recorded and verified with both client devices and system-integrated vehicles: Every time a pick-up is requested, any SSID in range of the mobile device 60, any client entered pick-up address, and GPS-determined latitude and longitude may be recorded by the client's mobile device 60. Further, every time a client is picked up or dropped off by a system-integrated vehicle, the same location specific information may be recorded by the vehicle's tablet computer 32. It is possible that an address may be incorrectly identified or misspelled, but an actual SSID from a nearby transmission (Wi-Fi, etc.) should confirm the location of the end-user.

In a further example, a system-integrated vehicle could take advantage of this by monitoring SSIDs while en route. The client application can alarm the driver visually or audibly as the vehicle approaches a destination. For example, known location-specific SSIDs in the area can indicate proximity to the destination. For example, the car can be notified at 100, 50, 25, 10, 5 meters.

The client application and the client management server 52 can also compare latitude and longitude to known addresses in the client's contact or favorites list and suggest possible alternative pick-up addresses. In case the GPS is in a low accuracy zone or no GPS signal is available, cellular triangulation or Wi-Fi could be used to determine the client's pick-up address. It is a distinct advantage to be able to access multiple sources for location data.

Once the client is picked up by the taxi, the client application enables functions during the trip (250).

The client application can track the location and route of client's trip once in progress. Once the vehicle arrives and the client is on board, the system may:
allow the client's mobile device to indicate the actuation of the billing system in the vehicle (e.g., the taxi meter) so as to monitor or ensure that proper billing has started
display the metered cost, updated during travel
checks the metered or driver-conveyed cost against published rates and tariffs to identify discrepancies
display the recommended or requested route from pick up location to destination, through text, visually, or audibly
concurrently display the actual route that has been and is being travelled by the vehicle from the time of pick-up for client comparison purposes; this may assist the client in determining if the driver is taking a more expensive or inappropriate route
both the recommended route and the actual route travelled may be overlaid on a map on the mobile device's display to aid in comparison
allow the client to select from several messages that can be sent from their mobile device that may be received by the driver's mobile device. For example, in the event a client is too shy to advise the driver, or is not fluent in the language spoken by the vehicle's driver, messages such as “Passenger uneasy, please drive more slowly” or “Passenger in a rush, please make the best time possible” may be transferred from the client's mobile device 60 to the tablet computer 32 or other hardware, including auto-translation into the driver's native language.

During the client's travel in the vehicle, the mobile device 60 may indicate points-of-interest as they are passed along the way. The client can take note of these and store any or all points-of-interest for later retrieval. For example, points-of-interest such as “Big Nick's Pizza” or “Multiplex Movie Theater” could be indicated on the mobile device's display as they are passed. The client may be able to select only those points-of-interest they wish to store for later recall as and when they are displayed. The client may also be able to set preferred points-of-interest, and may change their preferences as required. For example, when in a foreign city, a client might want specifically, or exclusively, to have shopping malls, barber shops, and steakhouses along their route, or within a specified distance or vicinity to be indicated. Selected points-of-interest may be stored locally on the mobile device 60 or elsewhere, and may trigger an e-mail to be sent to the client or another's e-mail address at the time the point(s)-of-interest are selected. The email may include additional information, such as additional details regarding the selected point-of-interest, advertisements, or offer promotions. Those points-of-interest offered to clients may require payment of a listing fee or other promotional consideration to have been given, in order to be included in the client management server 52 point-of-interest database. Listed points-of-interest may wish to indicate their offering of an electronic coupon that the client may select to acquire for later redemption using their mobile device 60. This coupon may be location based, and/or time based, or have other requirements associated. Similarly, listed points-of-interest may indicate special offers or sales that may apply only to client application clients.

A “panic button” or other similar emergency option may be available to the client during transit. For example, if the client believes the driver has malicious intentions, or is not an authorized driver, enabling or activating the panic button may send a message to the dispatching system so that the system 20 may pursue an immediate remedy. Other similar buttons might include “Passenger concerned about speed/safety of the driver's operation of the vehicle—please slow down” or “Passenger is in a hurry and prefers quickest possible route even if it is more expensive.” These messages could be displayed on the driver's mobile device in the driver's selected language. These messages may also be archived for data mining or other purposes. The messages may also be stored along with any of the previously described information in the client's recent trips folder.

Another example of a feature of the client application may be to enable the client to modify the route they wish the driver of their vehicle to take, from the suggested, or obvious route to a route the client would prefer. This may include the ability for the client to specify a request to make a stop at specific points along their preferred route. To assist with route modification or definition, the client may be able to preview the suggested route map on their mobile device either prior to or during the trip. This route map may also identify nearby points-of-interest. The client may be able to indicate their desired changes to the proposed route including by dragging points along the route line displayed on their mobile device's map and relocating them, by tapping them, or entering text or voice instructions, in order to indicate locations their modified route must pass, or points at which the client desires the vehicle to turn or pass as part of this altered route. As the client modifies the proposed route, the estimated fare may be recalculated and displayed.

After confirmation of and desired route change by the client, the client application and/or the client management server 52 and/or the transportation service provider system 24 may update the vehicle's driver, conveying the client's desired route changes. That update may include modified information that indicates the client management server's (and/or the transportation service provider system 24's) new recommended route, based on client's desired route changes.

For example, a client might wish to know what, if any, additional cost would be incurred to drive “through” Central Park in Manhattan to get to the User's final destination as opposed to following the client management server 52 or the transportation service provider system 24's proposed route around Central Park, and the client may then choose to confirm their request that the driver change the vehicle's route to go through Central Park. Another example could include the client modifying a route to allow a stop at a point-of-interest that was not passed via the initial route recommendation.

Another example of a feature of the client application/client management server 52 could be to compare the client's actual location (obtained via any combination of WiFi, cellular triangulation, GPS or otherwise) with the client's requested pick up address (obtained via any combination of WiFi, cellular triangulation, GPS or otherwise). If the system determines that the client has moved or is outside of an accepted range (for example walked a block after making a dispatch request), the client application could notify the client that it has identified a change from the specified pick-up location, and enquire if the client would like the vehicle to come to their newly identified location, or have the vehicle proceed to the original address.

Another example of a feature of the client management server 52 that may be included is real-time route optimization whose function may include evaluating traffic information, statistics, and/or status in real time, to determine optimum routing for its supported vehicles, and may also communicate other related information to supported vehicles pertaining to traffic and obstacles along their route or in the direction they are heading. Determinations may be based in part on real time traffic updates and other information from the transportation service provider system 24 or the taxi application or similarly enabled vehicles. They may also be based in part on and may also include analysis based on the reception of telemetric “chirps” sent at pre-determined and or regular intervals from appropriately enabled vehicles, that may communicate the vehicle's location, direction and speed with each ‘chirp’. This telemetric capability may be enabled by the taxi application or other mobile devices, or other similar tracking devices. Telemetric data may be received and stored by the transportation service provider system 24 or the client management server 52. The real-time route optimization feature may use that information to estimate, track and predict average vehicle speed on a given route at a given moment, and may include or use that information to determine average speed of traffic and other information with regard to a given road or section of road (or similar transportation conduit such as rail). Another feature may include interfacing the client management server 52 with police, municipal, or other information systems to monitor and or share emergency and accident reports and re-route vehicles accordingly in real time.

When the client arrives at his or her destination, their mobile device 60 indicates arrival (260). The mobile device 60 may display details of the trip, including elapsed time, departure and arrival times, distance travelled, difference if any between predicted and actual travel distances, times and/or routes, difference between the client's previous travels between the same two points, and the current trip.

The mobile device may also display the fee for the trip and related services such as night surcharge, extra rider surcharge, or bridge tolls as a total amount, or as a list of costs, and a total due.

The client may pay the fare which may include tip and other fees, using their mobile device

A tip calculation function may be available to aid the client, with features such as user-selected or preset percentage based options (e.g., 5%, 10%, 15%)

The client may be able to pay the fare using their mobile device 60, using one or more optional payment sources that may be pre-entered into the mobile device 60 by the client and recalled when making a payment. These sources may include a business credit card, a personal credit card, a debit card, a ‘gift card’ containing a pre-authorized credit amount, PayPal, a voucher, billing to an authorized corporate account, and billing to their account with their wireless service provider. It may also be settled by the client's redemption of accrued affinity points or rewards.

The client may indicate that they wish to settle the fee in cash directly with the driver.

Details of the client's payment facilities (e.g., credit card information) may be stored in protected form on the mobile device, for example by encryption, and/or on the client management server 52 and/or on the transportation service provider system 24, and may be accessed when the client is making a payment, and may or may not be displayed on the mobile device 60.

Once the total payment amount has been accepted, which may include the preferred payment method being selected by the client, the mobile device may require the client to input a PIN to authenticate the client and to authorize completion of the payment.

If an incorrect PIN is entered more than a predetermined number of times, the application may stop running, and may alert the client management server 52 of numerous incorrect authentication attempts, and/or the mobile device may be rendered unusable until it is confirmed that the user is an authorized client.

After completion and settlement for the trip, the client may be offered the opportunity, via their mobile device, to rate their satisfaction with the driver and/or the vehicle and give other feedback (270). The rating for driver and vehicle may be entered quickly into the mobile device by selecting from a number of ‘stars’ from one to five for each of driver and vehicle. Survey questions may also be offered. The ability to give detailed feedback via typed input or voice recording may be offered. Bonus incentives may be offered to the client for their participation in any of the above.

Passenger satisfaction bonus points are provided, whereby the transportation service provider system 24 or the client management server 52 monitor client ratings of all drivers and vehicles who use the system 20, and deposit points or other compensation to the drivers' accounts based on the ratings they receive. 4 and 5 star ratings only accrue points for a driver. A 4 star rating earns one-half point, while a 5 star rating earns 1 point. Bonus points or other forms of compensation can be redeemed by drivers for various benefits. The rating may be entered into the mobile device by selecting from a number of ‘stars’ from one to five for each of driver and vehicle. Other criteria may be available for the client to rate. Survey questions may also be offered. Bonus incentives may be offered to the client for their participation in any of the above.

The ratings can be used to ensure that only drivers and vehicles that meet the minimum standards are dispatched. These standards may be set by the client, the transportation service provider, by preset values, or by other means.

Client ratings of the vehicle and/or the driver are stored in the transportation service provider system 24 and the client management server 52. Such stored data may be mined to identify, for example, regular or trending client ratings of individual drivers, vehicles or transportation service providers. Such mined data may be used to select and reward or warn and or weed out affiliated transportation service providers, vehicles, and/or driver.

The client may indicate a preference for the driver, vehicle, or combination of both, or based on other factors described above, so that if that driver and/or vehicle, or a comparable driver and/or vehicle, is nearby or available when the client makes a subsequent dispatch request, the client may be given the option to offer the fare to that driver first rather than to another or default driver and/or vehicle.

Another example of a feature of the client application that may be included is an “Oh No!” or “recall” function, which may initiate an attempt via the transportation service provider system 24 or the client management server 52 to immediately recall a driver and vehicle to the location where the client was dropped off, or to their current location in the event. A client may wish to use this function, for example, if they left an item in the vehicle—e.g., their wallet or property. Using the “recall” function, the client may retrieve details of the vehicle that they last rode in and request its immediate return. In the case where the vehicle is not available within a user defined or preset period of time, for example if a driver's shift is over, the vehicle is being driven by another driver, or the vehicle has acquired another client, the client application may communicate the relevant information to the client management server 52 or the transportation service provider system 24 and the system or its operators may follow up with the client via their mobile device, for example to schedule delivery of the forgotten item. Alternately, the request may be given to a client service representative for appropriate follow-up. The client may also be able to enter details of the forgotten item(s) which may be relayed to the driver of the appropriate vehicle via the client management server 52 or the transportation service provider system 24 to the driver's mobile device 60, so as to aid the driver in determining if said forgotten items are in his vehicle. The driver may be able to respond to the client in a similar manner, to acknowledge or deny possession of the described items.

Another example of a feature of the client application that may be included is “Fast Cab.” This may be an abridged version of a new trip scheduling. A client may select this function when they prefer a more streamlined dispatch request process, aimed at allowing the client to access their transportation service vehicle as quickly and simply as possible. The “Fast Cab” feature may consist of different components from and only certain components of the new trip scheduling, some of the differences which may include the following:
entering a destination—this may include the option to simply define or select from nearby points-of-interest; e.g., gas station, police station, hospital, airport, or restaurant, or may offer the option not to indicate any destination
ignoring any predefined user/vehicle preferences.

The client application includes a “Take Me Back” function that simplifies the client's required steps to request an appropriate vehicle to transport them from where they arrived via the last trip, back to where that trip originated. This may be accomplished by automatically recalling and reversing the start and end points of the most recent trip.

The client may use this feature to acquire a return trip vehicle, or they may specify a preferred pick-up time which may indicate to the client management server 52 or the transportation service provider system 24 system that the dispatch request should be delayed until it is appropriate for this system to automatically issue it, an appropriate number of minutes before the pre-booked pick-up time. The appropriate number of minutes prior to the specified pick-up time for the dispatch request to be sent may be calculated by the client management server 52 or the transportation service provider system 24 system based on algorithms designed to accurately estimate that time period dynamically and may consider factors like number of available vehicles, traffic, and weather in its calculation.

The client application includes a “Got A Cab” function that allows the client to utilize certain functions of the client application even if they activate the “Got a Cab” feature subsequent to acquiring their taxi, for example, from a taxi stand by hailing or other traditional access means. Once in a vehicle, the client may use this feature to access certain features of the trip in progress component and other components of the new trip scheduling, as described above. These features may include the ability to pay the fee via their mobile device. The route tracking and other capabilities may be activated using the client's mobile device when they enter an affiliated vehicle ID or scan a code such as a QR code using their mobile device, and it is authenticated by the client management server 52 or the transportation service provider system 24. The vehicle ID may be entered at the start of or at any time during the trip. Once activated, the client's mobile device 60 may begin to receive the vehicle's metered charges information and/or other trip information via the transportation service provider system 24 or the client management server 52.

The client application calculates fare splitting. This feature enables two or more people in a system-integrated vehicle to split the fare between them using any of several determination methods. By entering or confirming any of a number of identification methods (perhaps including a system-integrated vehicle ID or the client application trip ID), the client application then distributes the fare and convey each user's share to them for settlement. Individual fare allocations can be calculated in a number of ways, for example manually by the client(s), according to change in metered fare between their embarkation and exit, split equally between clients, or in other ways. The fare split can be evaluated based on multiple riders' embarkation and exit locations, and or a fixed price for certain riders could be established between all riders, and confirmed using the client application. Each discreet user may also submit individual tip amounts at the time they exit the vehicle. For example, if client A gets out before client B—the client application can split the fare to that point and charge a portion to client A leaving client B to cover the remaining portion of the fare up to that point and what ever the remainder might be until client B arrives at their final destination.

The features described above are applicable to both public as well as private transportation, for example the client application users might find each other via a “social networking” component, with a view to sharing a private car rather than taking a cab. For example, the client application user may send a request to another person with a smartphone, seeking to share a private ride. In addition, many features described above may not require a taxi or other commercial vehicle with the transportation service provider system 24 connection, and could be facilitated by communications from the client application user to the client application user (including possibly via the client management server 52) to let private individuals request/share/offer rides in their own private cars to one and other.

Another example of a feature of the client application is traffic warnings for dispatch requests, either pre-booked or in progress. These warnings may alert the client in real-time to then-existing traffic conditions, or may be delayed such that the client is alerted to traffic conditions that existed at a prior time. Traffic conditions may be monitored by the client management server 52 using third party providers or by interpreting location, speed, direction, and other data from system-integrated vehicles. In the event that slower than typical traffic speeds, required detours, bad weather, or other factors that may impede or slow a trip are identified, appropriate information may be sent to system-integrated vehicles informing their drivers of these conditions. The client management server 52 or the transportation service provider system 24 may also make suggestions for alternate routes and identify predicted changes in departure/arrival times. The client may also be notified via the client application. Any of these notifications may be initiated by any of (but not limited to) the following conditions:
the vehicle will be later than expected for a dispatched or pre booked pick-up
the journey is expected to take longer than it would under typical conditions

In the case of a pre-booked pick-up, where the journey is expected to take more (or less) time than it would under typical conditions, the notification may include a recommendation that the user update their requested pick-up time accordingly

The client application can revise estimated fares based on real time traffic trends. For instance, prior to pick-up or while en route, the client application may notify the user of changes in anticipated conditions, and update the client regarding delays, the predicted change in ETA, or the predicted change in total fare or other costs that may result.

The client management server 52 includes a client Web interface that includes:
Access to the users profile, and the ability to insert, amend or append information and preferences for that user. This may include data pertaining to payment preferences, rules and options, and credit card or account information
ability to connect in a secure manner such as via 128 bit SSL
Detailed and/or downloadable access to a complete and searchable trip history which may include dates and times of travel, routes taken, amounts paid, payment method, and purpose of trip.
Downloadable information may be available in various file formats, including those intended to be accessible by various accounting software systems—e.g., AccPac, Quickbooks
Email preferences—Each trip when completed can email a receipt and/or trip review, that includes any number of preset or customizable trip details, to the end user based on these preferences or as requested by the user, and may include the ability to specify rules for determining which trips might be emailed to one address (e.g., personal) or another (e.g., office).
The ability for a client to make a trip request or enter or modify pre-booked trips, and specify preferences online using this interface (rather than a mobile device)
The ability for an authorized user to monitor or acquire the location or route taken by a transportation service vehicle that is carrying a client. This may be of interest to parents, for example, who may want to have certainty that their child while in such a vehicle is safely en route to the expected destination.
The ability to input amend, append, and specify rules and addresses for arrival verifications and similar alerts, which may be sent via email or SMS, for example to a parent or other individual, to notify them when child or other person arrived at the specified destination
The ability to define user groups for specified users intended to be associated with one billing account. For example, all employees within a company or a specific department who are authorized to make their payment via a pre-established company account. Once defined, these groups may also enable the client management server 52 or the transportation service provider system 24 to generate batched billing and reporting that may be accessed by a corporate expense management system.

Another feature of the client application is a virtual tour guide. Visual or audible information can be communicated to the client regarding route-related points-of-interest or other information as they approach them, allowing them to get some background or other information of potential interest regarding each point-of-interest, and may allow them to visually see the point-of-interest as they pass it on their route. This may include geographically, politically, culturally and or historically significant information, and may also include information regarding ephemeral details such as special events or closings at the specified points-of-interest. Information may also include promotional information such as advertising, the offer of electronic coupons etc. For example, when visiting New York, a traveler might wish to know about entertainment-related points-of-interest along the route from the airport to their hotel. For example, as the are passing Carnegie Hall, the client application could alert them to the point-of-interest, and communicate its significance and or other information. This information may be pushed to the user as they pass each point-of-interest, or pulled by their mobile devices as points-of-interest are identified. The criteria for which points-of-interest are identified and which information is offered may be based on client settings or preferences.

Another feature of the client application is basic roadside assistance. Users could make requests for towing, gas, jumper cables etc. from system-integrated vehicles. If a vehicle such as a taxi is able to bring gasoline, or provide other assistance, the vehicle driver or client may accept the offer. This assistance may be at a fixed tariffed or negotiated rate, may be chargeable to the client, and may be communicated to the client for their acceptance prior to the assisting vehicle being dispatched.

Another feature of the client application is voiceprint identification to confirm the client's identity. This form of identification may be used to authorize a payment made via their mobile device. For example, at the end of a trip, a client may utter a phrase when asked to acknowledge their acceptance of a charge or fee or the fare, such as “I authorize this payment”. the client application and/or the client management server 52 may analyze the captured audio to attempt to verify their identity, and may not accept the instruction if it is unable to confirm the client's identity within certain accuracy criteria.

Similarly, in mobile devices with cameras, facial recognition technology may be used to confirm the user's identity.

Any or all of these options, accessible to the client's mobile device 60 or other electronic device, described above and elsewhere herein, may also be accessed or monitored by or on another mobile device or other electronic device.

In another embodiment, system-integrated vehicles can constantly broadcast an SSID or some other type of signal. By accessing a specific broadcasted signal, the client operating a mobile device 60 with the client application installed thereon can “hail” a vehicle in range without having one dispatched through the transportation service provider system 24. For instance if a car is across the street the client application could digitally hail the car to the client bypassing the dispatching process.

If the vehicle and/or tablet computer is equipped with a camera, an image or series of images may be automatically captured and stored when the meter is stopped, or payment is confirmed, or at any point during a trip, and in the event that the rider claims they have left their property in the vehicle, these photos may be retrieved to confirm or repudiate their claim. This may prevent vehicle drivers from dishonestly denying that property was left in their vehicle so that they may keep it for themselves. Camera imagery can also be captured in the event of a collision, triggered by impact.

Another example of a feature of the client application that may be included is “push” notifications which function may alert clients to important information using the “push” functionality of their network services provider and/or mobile device. Notifications may alert the client to such information even if the client application is not actively running on their mobile device 60 when the information is sent. “Push” notifications when received by the client's mobile device may trigger an audible, visual or vibration alert to make the client aware of their reception. Such information may include alerts regarding traffic congestion which may delay the arrival of a vehicle that has been dispatched to them, or alerts for pre-booked trips which may recommend to the client that the dispatched vehicle should be rescheduled to arrive to fetch them a recommended number of minutes earlier than scheduled. The recommended number of minutes may be based on a determination algorithm in place at the transportation service provider system 24 or the client management server 52. This may help the client to arrive at their intended destination, such as an airport or appointment, at a particular time, despite predicted delays. Other notifications may include, for example, weather warnings that may warn regular users that impending bad weather may influence their ability to access a vehicle at the usual time, or warn them that transit times anywhere in their area may be longer than usual. “Push” notifications may also be initiated by the driver of a vehicle that has been dispatched to a client, and may be sent from the driver's mobile device, via the transportation service provider system 24 or the client management server 52 to the client's mobile device. All communications between the client and driver may be direct after a vehicle has been selected, or may be routed through the system e.g. via the transportation service provider system 24 or the client management server 52. These notifications may include custom or preset messages such as “I am less than two minutes away” or “I have encountered unexpected traffic, and may be delayed a few moments” or “It seems you forgot something in my vehicle, should I return with it to you?” In the case of the latter message, the client may be able to reply either by preset button choices such as “yes” or “no” or may be able to sent a custom message like “please bring the article back to your central station and leave it for me”. This type of message may be sent via SMS or some other communications method, and may be sent via the client management server 52 and/or the transportation service provider system 24.

Users, which may include client, dispatch system user, call center user, and vehicle operators/drivers, may interact with the system using a Web-based interface, or other computer or electronic device-based interface.

In interacting or communicating with the tablet computer 32, and or dispatch systems, and or client's systems, the client management server 52 may facilitate or install software and/or firmware updates and enhancements, and/or activation or deactivation and or authorization and or de-authorization of these devices or their applications.

Another example of a feature of the client management server 52 can include is “smart suggestions.” Which function may accesses a database of information regarding transportation services including those which may be connected to or accessed by the client management server 52 or the transportation service provider system 24 directly and provide information regarding, and may provide direct connection to these services the client via the client application and or their mobile device. The accessible data may include information on particular transportation service providers (for example small local taxi companies), that may offer better service and or more transportation options in specific areas, and or at specific times. Based on this data, the client management server 52 may analyze this data and/or make recommendations to a client, based on some combination of one or more of criteria such as their specified requirements, preferences, location and time of day. The client management server 52 may communicate recommendations to clients via the client application app and or their mobile device. “Smart suggestions” may offer clients a list of recommended local transportation service providers and their contact phone numbers, with links to dial them, and or web booking URLs with links to access them, and may indicate their estimated desirability or reasons for desirability based on assessment of the above data.

Another example of a feature of the client management server 52 that may be included is driver accident and emergency protection which function may capture audio and or video from the tablet computer 32 or other electronic device, which may be mounted in the vehicle. In the event of a vehicle being involved in an accident, an amount of the recorded data leading up to the accident, which may continually be stored in a temporary cache on the mobile device or elsewhere, may be automatically uploaded to the client management server 52 directly or via the transportation service provider system 24, or to the transportation service provider, for storage and analysis. In the event that the data captured by the mobile device or other electronic device becomes inaccessible from such devices, a copy stored for example by the client management server 52 may still be accessed to, for example, indicate that the driver was not at fault in the accident.

Another example of a feature of the tablet computer 32 (or other device mounted to a system-integrated vehicle) is to capture audio/video. This data could be stored locally or transmitted either in real time or as a batch to a network storage system. Images and/or audio of in-car or street views can be accessed for a variety of purposes. For example:
Homeland Security
surveillance
building a street view database or contributing to a 3^{rd} party service such as Google Street View

Also, a driver “panic button” may be part of their mobile device's or other electronic device's software, or a physical button located in a location in the vehicle that may be actuated by the driver in the event of a robbery or other critical event. Upon actuation, the “panic button” may send location and or other information regarding the vehicle and its situation to the client management server 52 and the client management server 52 may initiate appropriate action to aid the driver upon receipt of such information. The driver's mobile device may also automatically upload audio and/or video it captured during a period leading up to the actuation of the “panic button”. This may assist in confirming the actual events, for example by identifying someone involved in the event, and the captured data may be uploaded automatically to the client management server 52 and stored for later retrieval in the event that the driver's mobile device or other electronic device is stolen. Another feature of driver accident and emergency protection may include the ability of the transportation service provider system 24 and or the client management server 52 enabled driver's mobile device to continuously ‘record’ the vehicle's location and speed of travel for the duration of that driver's shift to a local cache. One possible benefit could be that in the event the driver receives a speeding ticket, they can instruct their mobile device to upload the cached data containing this information to the transportation service provider system 24 and or the client management server 52. The driver's speed of travel at the specific location and time at which they were charged with the offence could be accessed in the event that they legitimately refute the charge. This data may be stored in an encrypted format to which they do not possess the key so as to eliminate any question that they may have tampered with it.

Another general feature of the client management server 52 is augmented reality location services”, wherein the system 20 supports the ability of the client to visually identify and isolate the particular vehicle that has been dispatched to them from amongst several possibly similar vehicles and other objects, once in visual range of the client by overlaying the system-integrated car's information on the appropriate vehicle over or beside the actual image of the vehicle, as it appears when seen through the client's mobile device's camera. This can assist the client in situations of heavy traffic where they may be able to visually see many vehicles but have difficulty distinguishing their dispatched vehicle for other vehicles. Conversely, system-integrated drivers can use the same technology to identify their target client (the client) and the client application user information as they become close enough to see. In a transportation services vehicle this feature may be provided by a “heads up display” which projects information retrieved from the client management server 52 or a similar service onto the inside of the vehicle windshield such that things they actually see optically through the windshield have data overlaid on them.

The client management server 52 can include social networking ride shares, whereby the client application users may be able to identify each other's location, and/or destination, and/or route, and/or purpose of travel, and may interact with each other directly or otherwise. In some cases clients may wish to use the client application and/or the client management server 52 to identify opportunities to plan or share private transportation rather than transportation service providers (for example to car-pool or to offer or receive a non commercial ride that may be free or fee-based). Some of the ways this could happen include the following:
The client application user can locate a specific friend or broadcast to all of the friends in his or her “buddy list” and ask to share a ride (for example people leaving a nightclub, office, or after a show or sporting event)
The client application user can search for friends or others nearby and offer a “take me to my friend” option that dispatches a transportation service vehicle, or identifies and facilitates communication with a private vehicle or its owner, to provide transportation to that friend (for instance at a near by pub).
The client management server 52 could monitor for clients that frequently travel to and/or from the same areas at approximately the same time and suggest a “ride buddy”. For instance users traveling from midtown to downtown every morning approximately 8:30 and automatically suggest they become “ride buddies”.
The client management server 52 could provide a searchable bulletin board or forum for ride share requests where a client, for instance could search or post a ride request to a specific location at a specific time.
The client management server 52 could monitor pre-booked trips for similar trips and suggest a ride buddy. For instance: midtown to the airport around 7 am. The client management server 52 could automatically ask all parties if they'd like to share the ride and handle the routing and distribute new pick-up times.
The client management server 52 could monitor new trip requests as they are received (and/or pre-booked trips described above) to identify similar trips as requested by other riders, and suggest a ride buddy who may want to share the ride. For instance: midtown to the airport around 7 am. The client management server 52 could automatically ask all parties requesting this or a reasonably similar if they'd like to share the ride and handle the routing and distribute new pick-up times.

In another embodiment, the system 20 can include a “man behind the curtain call center” which may provide semi-automated or manual completion of dispatch or similar requests made by a client located in a non the transportation service provider system 24 and/or the client management server 52 enabled service area. In this scenario, the client can interact with the client application just as they may in a fully enabled area, however their digitally acquired dispatch request and related information is rerouted via the client management server 52 to a human operator at a call center. The operator receives the data from the client's dispatch request on a terminal and may then manually request the dispatch of the appropriate vehicle from a local transportation service. The operator may collect the typically required information regarding vehicle number, driver name, ETA and other data, similar to that which may be acquired in an instance when the client management server 52 was able to communicate digitally with the transportation service provider system 24 from the transportation service accepting the dispatch request, and could then transmit said information to the clients' mobile device via the client management server 52. This confirmation information when acquired by the operator, may be manually entered into the client management server 52 and may be displayed on the client's mobile device as it normally would in the case of a fully digital booking. The client's experience in this instance is intended to be (but may not be) almost indistinguishable from the standard experience. Human operators in the call center may be replaced or supported by Interactive Voice Response (“IVR”) technology in some cases.

Another example of the “man behind the curtain call center” approach includes IVR-based dispatch bookings. Here, the outbound call from the call center to the appropriate transportation service provider may be automated. The IVR system may place the call and relays the details received from the client via the client management server 52 to the human dispatcher on the receiving end of the call, and may use IVR technology to acquire the response from the contacted transportation service provider, which then relays it to the client via the client management server 52.

The client application can include vehicle tracking, which can show:
nearby vehicle locations
dispatched vehicle location, including as it approaches the user
current trip location, including while the trip is in progress
location of vehicle, for example when a “panic” feature is invoked

“Location accuracy enhancement services” can be used to improve the accuracy of GPS-based location services.
The client application user may be able to more accurately track which vehicle is destined for them, based for example on the strength of a Wi-Fi or other type of signal sent from the transportation service provider system 24 or similarly enabled vehicle.
Each vehicle may have its own discreet SSID or another identifier that may assist with user identification and may assist in differentiating said vehicle from others.
The client application client may receive data from the client management server 52 enabling it to uniquely identify said vehicle.
The client application client may be able to indicate proximity or relative proximity of said vehicle based on strength of the signal sent directly from said vehicle.
“location accuracy enhancement services” may be used to enhance the accuracy of other location based services.

In an additional embodiment, conversely:
A system-integrated vehicle may be assisted in identifying the proximity of an assigned client-based on the strength of a signal sent from the client application user's mobile device 60.
The vehicle may receive data from the client management server 52 and or the transportation service provider system 24 enabling it to uniquely identify said client's mobile device 60.

“Directional location accuracy enhancement services” can be used to improve the accuracy of GPS-based location services. A transportation services vehicle may be equipped with a small device containing multiple antennae configured in an array optimized for direction-finding. This device may be place inside or outside of said vehicle in order to enable it to receive a signal from a designated client client's mobile device and determine the direction from which the signal is coming relative to the vehicle. This device may also indicate received signal strength. This device may, through digital, analog or mechanical switching, enable only certain of its array of antennae to be enabled at a particular moment. The antennae within an array selected to be enabled may be selected based on a desired predictable, directional, radiation pattern that may be achieved by their enabling (this selection may for example be of 3 antennae within of horizontal circular array of 12 vertical antennae, located at 0, 120, and 240 degrees relative to each other). The device may switch its selection of enabled antennae and may do so in a pattern, such as a sequential circular pattern (electronically similar to the rotation of a radar dish). Received signal strengths as enabled antennae are selected may be compared and or analyzed either by technology internal or external to the device, such that the direction from which the signal is coming may be surmised. Signal strength may be communicated to the vehicle's driver visually, aurally (for example by a light or beeping sound which increases in frequency or intensity as strength increases) or by tactile means. Direction may be communicated to the vehicle's driver either visually, aurally, or by tactile means. Direction may also be communicated graphically, by voice readout or may be communicated by the moving the perceived location of a sound within a quadraphonic audio field within the vehicle such that the driver ‘hears’ the locator tone to their left, right, front or rear.

Fare bidding can be employed, wherein multiple transportation service providers may by given the opportunity to place bids via the transportation service provider system 24 and or the client management server 52 for the right to acquire a dispatch request, on a by-request basis or otherwise. This fare bidding may occur in real-time. This feature may offer a dispatch request or requests to authenticated systems of qualified bidders at a pre-determined or dynamically determined starting fee based on variable factors such as time of day, and/or predetermined factors that may include location, distance to travel, number of people to be picked up, intended destination of pick-up request, or other criteria. Participants who do not have an available vehicle within a specified distance of the pick-up location may not be allowed to bid for that dispatch request based on pre-set or dynamic rules. Participants who do not have an available vehicle that meets specified criteria may not be allowed to bid for that request. The fare bidding option may be activated when the client management server 52 is offering a dispatch request and two or more vehicles are available that meet specified criteria for bidding eligibility. In this case, the request may be offered to the one of those vehicles offering the highest bid, or may be allocated based on one or more other factors. The fare bidding option may be activated when the client management server 52 is offering a dispatch request and no vehicles are available that meet the specified criteria for bidding eligibility, or no vehicles accept the initial dispatch request offer. In this case, the fare bidding system may offer an incentive for a participant to accept a fare request, such as a payment or other compensation, which could escalate over time (as an upward bid) until a vehicle that meets the specified criteria accepts the bid and dispatch request. Participants in fare bidding may be able to specify their own criteria via the transportation service provider system 24 and or the client management server 52 to determine the maximum bid their system will place on a given dispatch request, the minimum compensation they will accept in some situations, or other minimum/maximum criteria that they may accept. These rules may be dynamically changeable. These rules and dynamic changes may be communicated in real-time or otherwise, or periodically from the transportation service provider system 24 or similar system to the client management server 52 or similar system that may be based on parameters established on an individual basis by participating Transportation Service providers. For example, if a given fleet is 95% utilized when a request is offered, their system may lower its maximum offer-able bid. As another example, if a fleet is underutilized or has a larger than desirable number of vehicles meeting the specific criteria of the dispatch request, that provider's maximum allowable bid amount for a dispatch request at that moment may be raised automatically. Conversely, for example, if a fleet is fully utilized, or during certain high demand periods, it may specify a minimum compensation amount starting point at which the Bidding System can enter a bid to have a dispatch request accepted.

Quick response incentives can be given to encourage drivers or transportation service providers to accept a dispatch request as quickly as possible. By way of example, dispatched dispatch requests may take up to 30 seconds to be accepted by a driver. In one embodiment of the “quick response incentives” feature, when the driver's mobile device or other electronic device indicates he or she is eligible (i.e., meets the minimum criteria) to accept a pending dispatch request, a timer may begin the instant the dispatch request is received and the period of time from receipt of the request to the driver's acceptance may be tracked by the transportation service provider system 24 or the client management server 52 or by the driver's mobile device and then relayed to the transportation service provider system 24 or the client management server 52 for tracking. Based on the amount of time that lapses from when the request is transmitted to the driver's mobile device or other electronic device and the driver's acceptance of the fare request, the system might increase or reduce incentives such as a referral fee for that fare. Such incentives could include, for example, monetary or point compensation, where such points could accrue to the driver and be redeemable for various benefits.

A photograph of the interior of the vehicle can be taken every time a vehicle's fare metering system is activated or some other criteria is met. Photographs of the area surrounding the exterior of the vehicle could be similarly taken, depending on the number and placement of equipment capable of taking photographs. Such photographs may be stored in the vehicle, or uploaded to the transportation services provider or the transportation service provider system 24 or the client management server 52. Such photographs may help to identify clients who engage in certain activities, such as committing or attempting to commit a crime against the vehicle or driver while receiving transportation services. Even in the event that the driver's mobile device or in-vehicle camera is removed from the vehicle or is inoperative, the transportation services provider, the transportation service provider system 24 or the client management server 52 may have a photograph of the client stored for future reference.

Sensitive data (for example, the client application client's, favorites, credit card and or billing information, recent trip activity, or any other specified data) may be stored in an encrypted form. For example, data that is stored locally on the client's mobile device may be encrypted.

Another feature of the system in accordance with another embodiment is a security feature that reduces the risk that an unauthorized party could gain access to the client's credit card data via their mobile device or via the client management server 52. This feature splits the data such that only a part of it is stored on the client's mobile device, and the remainder is stored elsewhere such as in the transportation service provider system 24 or the client management server 52 database, and the two parts must be conjoined in order to produce a usable dataset (e.g. the client's credit card number) and said conjoining may only be initiated at the moment said complete data set is required (e.g. when a credit car number is required to make a payment at the end of a taxi ride) after which, the conjoined (completed) data set is erased from temporary memory.

For example, a client when configuring the client application to allow payment using a credit card, may enter their full credit card number, CVV and expiration date, however, the client application may randomly extract a random number of digits from random locations in the credit card number and store only those numbers and their locations in the dataset locally on the client's mobile device, while transmitting the remaining data (less the extracted data) to the client management server 52 for storage. In doing so, the client's entire billing data is never permanently stored in one location. The client management server 52 stores some of the client's data, and retrieves the missing data and information describing where to place said missing data from the client's Mobile device only for as much time is required for a transaction requiring the full dataset to take place.

In some instances the data may be split such that part of the split data is extracted, and not stored anywhere digitally, and may be retrieved exclusively from the client's mental memory or by the client from outside the system. In this example, the extracted data may be entered manually into the client's mobile device by them only at such a time as it is required, then it may be transmitted to the client management server 52 along with information describing where to place said missing data into the portion of the data stored by the client management server 52, to facilitate recreation of a complete data set. This complete data set may be stored by the client management server 52 only for as much time is required for a transaction requiring the full dataset to take place.

The client's mobile device can cache map tiles and/or lists of street names and/or points-of-interest locally as they are received, so that subsequent requirements for this data do not require its being downloaded again.

Data of this nature pertaining to a city or area to which a client may be traveling, may also be selected and downloaded in advance for local storage and subsequent access prior to their departure from their data provider's local wireless area or a Wi-Fi access point.

Storing this data locally may allow the client to reduce bandwidth utilization fees and/or data roaming costs by eliminating the need to retrieve said data when needed at a destination or location where said data is costly or slow to download.

The client application can display promotional or sponsorship information and/or advertisements. These may include private labeling of the application or specific features, graphical banners, and/or audio and video loops. They may also include promotional offers and digital coupons. Determination of the specific data to be presented on an individual user's mobile device, and its type of format, could be determined based on numerous criteria including the client's current geographic location and/or specified destination (nationally, regionally or locally) as determined by the client's GPS or cellular location services and/or specified destination details, or may be based on client demographics or other information.

This data may be pre-cashed locally on the client's mobile device, and specific components may be called for presentation based on local criteria determined by the client application, or may be called based on criteria determined by the client management server 52. This data may be transmitted over a data network for display on the client's mobile device, and may be selected and transmitted by the client management server 52.

Vehicle performance efficiency and safety monitoring can be performed by the computing device in the transportation services vehicle (such as the tablet computer). In one embodiment, the tablet computer 32 or a similar device in a transportation services vehicle interconnects with the vehicle's engine management and/or other monitoring system(s) so that it may report certain desired information back to the transportation service provider system 24 when certain criteria are met. The information may be used to improve vehicle-operating efficiency, identify potential mechanical problems, identify potential road hazards, and identify vehicle accidents or break-ins. This information may include but not be limited to:
Information indicating that the vehicle's motor or other systems are not operating properly or are not operating within certain specifications; e.g., in the event that a vehicle's fuel consumption becomes abnormally high
Information indicating that the vehicles anti lock break system or stability control system has been actuated; perhaps indicating that the surface conditions where that particular vehicle is driving are not optimal.

Information indicating that the vehicle's air bags or other crash protection or security features such as the vehicle alarm, have been deployed.

Vehicle gas mileage monitoring can be provided by the tablet computer. This feature may help fleets identify individual vehicles whose gas mileage has deviated significantly from the expected mileage for that type of car.

At each fill-up the vehicle driver enters into the transportation service provider system 24 via the tablet computer 32 or similar device the quantity of fuel put into the car at that time. The transportation service provider system 24 may then calculate the vehicle's approximate fuel efficiency based on its accumulation and analysis of the following data: the volume of fuel put into the vehicle since the last fueling, the distance that vehicle travelled since its last fuelling, and its approximate speeds at various times during its travels (weighting the calculation based on road conditions and speed).

The client may be able to access various ‘widgets’ from within the application while awaiting their vehicle's dispatch confirmation or arrival. These may include information services including but not limited to weather, stock market, news headlines, or games, and may be accessed via the mobile device's web browser, or sent to the mobile device from the client management server 52. These widgets may include brand identifiers; e.g., “Courtesy of Bloomberg”, or may contain sponsorship information; e.g., “Brought to you by Coke”, or may contain other information such as promotional or advertising information.

Other methods of permitting the client to authenticate to the client application can be used, such as via biometrics, a face scan, a voice scan, etc.

The tablet computers can be substituted with other computing devices. For example, it may be a purpose-built device, can have a keypad or keyboard input interface, etc. and need not have a touchscreen, or it may have a separate processor housing with remote display or displays. Another alternative could be an appropriately equipped consumer smartphone.

The functionality provided by the transportation service provider system 24 and the client management server 52 can be placed on the same physical computer or computer system.

Computer-executable instructions for implementing the method of coordination of transportation service on a computer system could be provided separately from the computer system, for example, on a computer-readable medium (such as, for example, an optical disk, a hard disk, a USB drive or a media card) or by making them available for downloading over a communications network, such as the Internet.

One or more portions of the method may be executed by third parties.

The above-described embodiments are intended to be examples of the present invention and alterations and modifications may be effected thereto, by those of skill in the art, without departing from the scope of the invention that is defined solely by the claims appended hereto.

What is claimed is:

1. A method for coordinating transportation service, comprising:
receiving a request for a trip generated by a client application executing on a mobile device;
determining which one of a set of transportation vehicles is best suited to provide said trip; and
automatically dispatching said one transportation vehicle to provide said trip.

2. The method of claim 1, wherein said automatically dispatching is delayed if said request for said trip specifies a delayed pick-up.

3. The method of claim 1, wherein said receiving comprises:
receiving a preference for a route for said trip with said request.

4. The method of claim 3, wherein said preference corresponds to a characteristic of said trip.

5. The method of claim 4, wherein said characteristic includes at least one of: duration, smoothness, scenery, and directness.

6. The method of claim 3, wherein said preference corresponds to at least one location along said route.

7. The method of claim 1, further comprising:
determining a best route for said trip; and
transmitting said best route to said mobile device.

8. The method of claim 7, further comprising:
presenting the location of said mobile device relative to said best route on said mobile device.

9. The method of claim 1, wherein said receiving comprises:
receiving a pick-up location, a drop-off location and a desired pick-up time.

10. The method of claim 9, further comprising:
receiving the geolocation of said mobile device, and
estimating if said mobile device is expected to be at said pick-up location at said desired pick-up time.

11. The method of claim 9, further comprising:
receiving the geolocation of said mobile device; and
transmitting a prompt to said mobile device if said mobile device is a threshold distance from said pick-up location, said prompt enabling a client operating said mobile device to specify a revised pick-up location.

12. The method of claim 9, further comprising:
iteratively receiving the geolocation of said mobile device, and
determining if said mobile device appears to be in a vehicle traveling to said drop-off location.

13. The method of claim 1, further comprising:
providing said trip;
receiving a recall request for said one transportation vehicle; and
automatically dispatching said one transportation vehicle to a drop-off location for said trip.

14. The method of claim 1, further comprising:
reiteratively transmitting the geolocation of said one transportation vehicle to said mobile device.

15. The method of claim 1, further comprising:
automatically transmitting an estimated arrival time at a pick-up location to said mobile device.

16. The method of claim 1, further comprising:
receiving a subsequent request for a separate trip generated by said client application executing on a second mobile device; and
considering said one transportation vehicle dispatched to provide said trip when determining which of said set of transportation vehicles is best suited to provide said separate trip.

17. A system for coordinating transportation services, comprising:
a transportation service provider system having a network interface receiving a request for a trip generated by a mobile device and receiving geolocation information from a set of transportation vehicles, said transportation service provider system executing an application determining which one of said transportation vehicles is best suited to provide said trip and automatically transmitting dispatch instructions to said one transportation vehicle.

18. A method for coordinating transportation service, comprising:
reiteratively receiving geolocation information from a first mobile device of a first client and a second mobile device of a second client;
providing a first trip to said first client with a transportation vehicle;
providing a second trip to said second client with said transportation vehicle, at least a portion of said second trip being provided simultaneously with said first trip; and
determining a pro-rata portion of transportation service charges incurred during occupancy of said transportation vehicle by each of said first and second clients.

19. The method of claim 12, further comprising:
reiteratively receiving geolocation information for an other of said transportation vehicles; and
determining if said mobile device is in said other transportation vehicle by tracking colocation of said mobile device and said other transportation vehicle.
